(19) United States
(12) Patent Application Publication
(10) Pub. No.: US 2007/0252826 A1
(43) Pub. Date: Nov. 1, 2007

(54) Roller structure for input devices

(75) Inventor: Chun-Ching Peng, Chung Ho City (TW)

Correspondence Address: Raymond Y. Chan, Suite 128, 108 N. Ynez Avenue, Monterey Park, CA, 91754, US

(73) Assignee: Chic Technology Corp.

(21) Appl. No.: 11/413,914

(22) Filed: Apr. 27, 2006

(51) Int. Cl. G09G 5/00

(52) U.S. Cl. 345/184

(57) ABSTRACT

A roller structure for input devices with improvement is disclosed. The roller structure of the present invention comprises a roller, a supporting seat, an encoder, a circuit board, a contact switch and a roller supporting seat. The supporting seat is disposed within the roller, and a space is provided on one side of the supporting seat so that the encoder is fixedly disposed in the space and hence the roller structure has a smaller size. A contact switch is provided on the circuit board. Two positioning protrusions are provided on the outside of the supporting seat and two positioning tracks are provided on the roller supporting seat so that the movement of the supporting seat may be guided and limited by the roller supporting seat. An activation protrusion is provided on the two positioning protrusions and may activate the contact switch when the supporting seat is pressed down.

### BACKGROUND OF THE PRESENT INVENTION

1. Field of Invention

The invention generally relates to an improved roller structure for input devices. More particularly, the invention relates to a roller structure that the size of the input device is substantially reduced, is easy to use and has a nice feel and that inadvertent errors may be avoided.

2. Description of Related Arts

As of now, there are several roller types of input devices (such as mouse and track ball). In the beginning, these input devices were used to allow a user to point and use a browser. Then, these input devices have been used in various kinds of software and have become an indispensable input tool. With the development of various kinds of software, additional control keys and buttons have been added to the limited room of input devices.

Also, some input devices are used as portable input devices and hence these input devices have to be compact. Because of the limited room of input devices, many functional keys and functions can not be put on input devices. In the input devices currently available on the market, input devices with more functions are relatively bigger, and input devices that are portable have much less functions. Hence, there is a need to make input devices more compact by employing an improved structural design.

The structure of a roller of the prior art is shown in FIGS. 1 and 2. The roller structure of the prior art comprises a roller 11 and an encoder 12. The encoder 12 can detect and encode the rotation directions and distances of the roller 11 so that the corresponding cursor may move around accordingly. An output shaft 13 is used to connect the roller 11 with the encoder 12. The use of the output shaft 13 makes the width of the input device equal or bigger than the combined width of the roller 11 and the encoder 12.

The structure of an optical roller of the prior art is illustrated in FIGS. 3 and 4. The optical roller of the prior art comprises a roller 21 and an optical encoder 22. No output shaft is used, and the optical encoder 22 can detect and encode the movements of the roller 21 via the variations in the surface of the roller 21. Because the optical encoder 22 is disposed outside of the roller 21, the input device has a relatively large volume.

The design to facilitate the downward movement of the roller is important too. FIG. 5 is a perspective view of the roller structure of the prior art, showing its contact switch 14. The contact switch 14 is disposed below the output shaft 13 and on the opposite side of the encoder 12. The encoder 12 is used as the pivot; the force is applied on the roller 11; the point of resistance is at the contact switch 14. According to the physics of lever, because the point of applied force is between the pivot and the point of resistance, the mechanical advantage of such lever is smaller than one. Hence, a user tends to apply bigger forces, which often damage the components. Also, the force applied by a user is curved sideways and hence a user needs to use bigger forces, which cause fatigue to the user's hand.

FIG. 6 is a perspective view of the optical roller of the prior art, showing its contact switch. Two positioning tracks 25 are provided so that the movement of an output shaft 23 may be limited by the two positioning tracks 25. A contact switch 24 is disposed on the other side opposite to the tracks 25. Because there is no pivot, most of the force is applied on the contact switch 24 so that the contact switch 24 is easily damaged. Also, because the distance between the tracks 25 and the contact switch is relatively large, sideway component of a force may be easily generated and hence may damage the parts of the input device.

From the above, we can see that the input devices of the prior art have many disadvantages and need to be improved.

To eliminate the disadvantages of the input devices of the prior art, the inventor has put in a lot of effort in the subject and has successfully come up with the improved roller structure of the present invention.

### SUMMARY OF THE PRESENT INVENTION

A main object of the present invention is to provide an improved roller structure that the size of the roller structure may be substantially reduced and hence the size of the input device may be reduced.

Another object of the present invention is to provide an improved roller structure that is easy to use and has a nice feel and that inadvertent errors may be avoided.

A third object of the present invention is to provide an improved roller structure that is accurate and has a longer service life and that improper use and hand movements of the input device do not cause any adverse effects.

In order to accomplish the above objects, the roller structure of the present invention comprises a roller, an encoder, a supporting seat, a contact switch, a circuit board and a roller supporting seat. A groove is provided on one side of the roller. A space is provided on one side of the supporting seat. The supporting seat is disposed within the groove of the roller. The encoder is fixedly disposed in the space. A slot is provided on the supporting seat so that the wires of the encoder may be extended through the slot. The circuit board is disposed under the roller. A contact switch is provided on the circuit board and may be activated by the downward movement of the supporting seat. The roller supporting seat is disposed under the circuit board and serves to carry the aforesaid components. Two positioning protrusions are provided on the outside of the supporting seat; two positioning tracks are provided on the roller supporting seat so that the movement of the supporting seat may be guided and limited by the roller supporting seat. A rotation shaft is provided on the roller. A positioning plate is provided on the roller supporting seat, and a hole is provided on the positioning plate so as to allow the rotation shaft of the roller to rotate in the hole. An additional space is provided on the hole. An activation protrusion is provided on the two positioning protrusions and may activate the contact switch when the supporting seat is pressed down.

These and other objectives, features, and advantages of the present invention will become apparent from the following detailed description, the accompanying drawings, and the appended claims.

### BRIEF DESCRIPTION OF THE DRAWINGS

The drawings disclose an illustrative embodiment of the present invention which serves to exemplify the various advantages and objects hereof, and are as follows:

FIG. 1 is a perspective view showing the roller structure of the prior art.

FIG. 2 is a side view of the roller structure of FIG. 1.

FIG. 3 is a perspective view showing the structure of an optical roller of the prior art.

FIG. 4 is a side view of the roller of FIG. 3.

FIG. 5 is a perspective view of the roller structure of the prior art, showing its contact switch.

FIG. 6 is a perspective view of the optical roller structure of the prior art, showing its contact switch.

FIG. 7 is an exploded view of the roller structure of the present invention.

FIG. 8 is a cutaway view of the roller structure of the present invention.

FIG. 9 is a perspective view of the assembled roller structure of the present invention.

FIG. 10 is another perspective view of the assembled roller structure of the present invention.

FIG. 11 is a side view of the roller structure of FIG. 9.

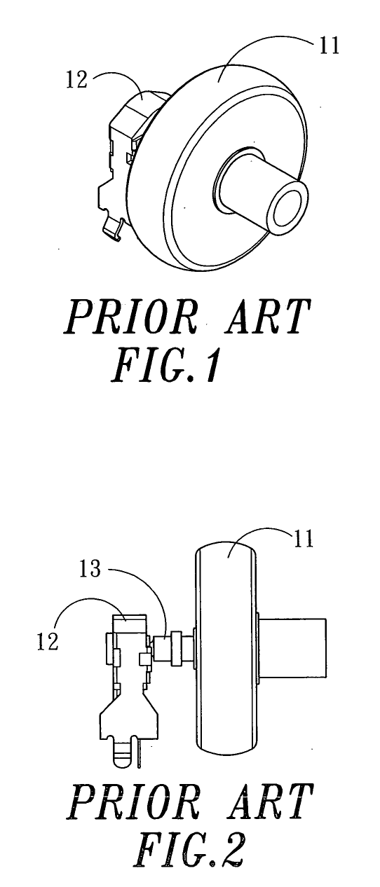

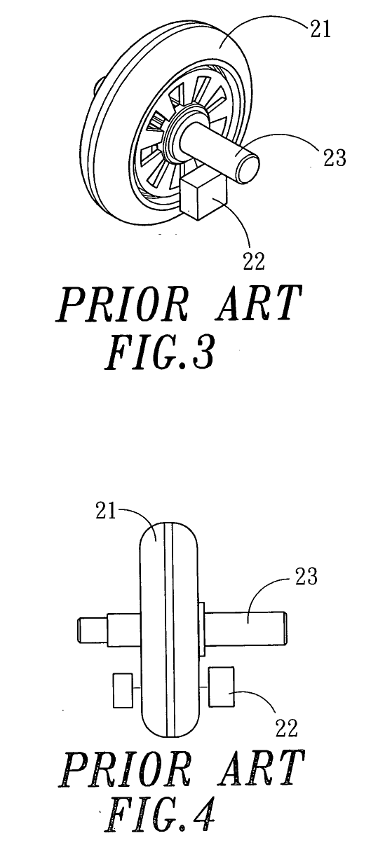

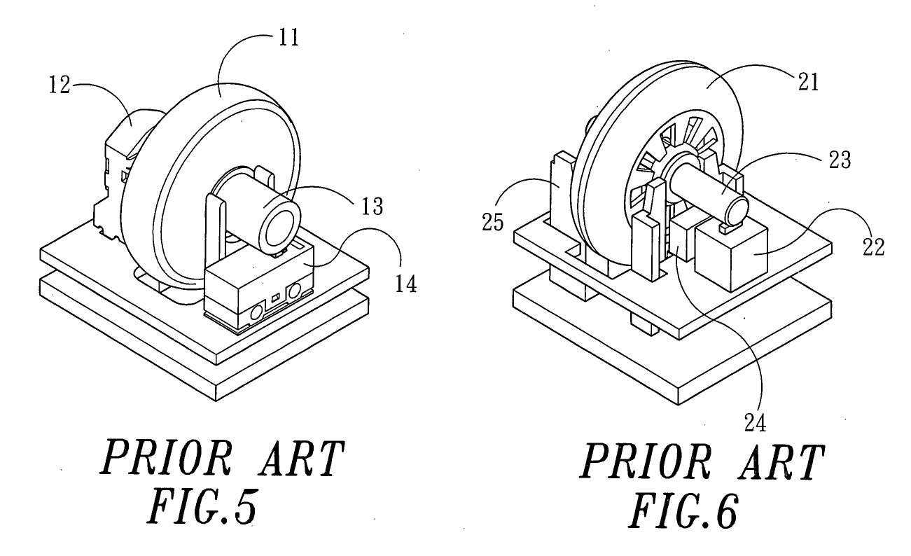

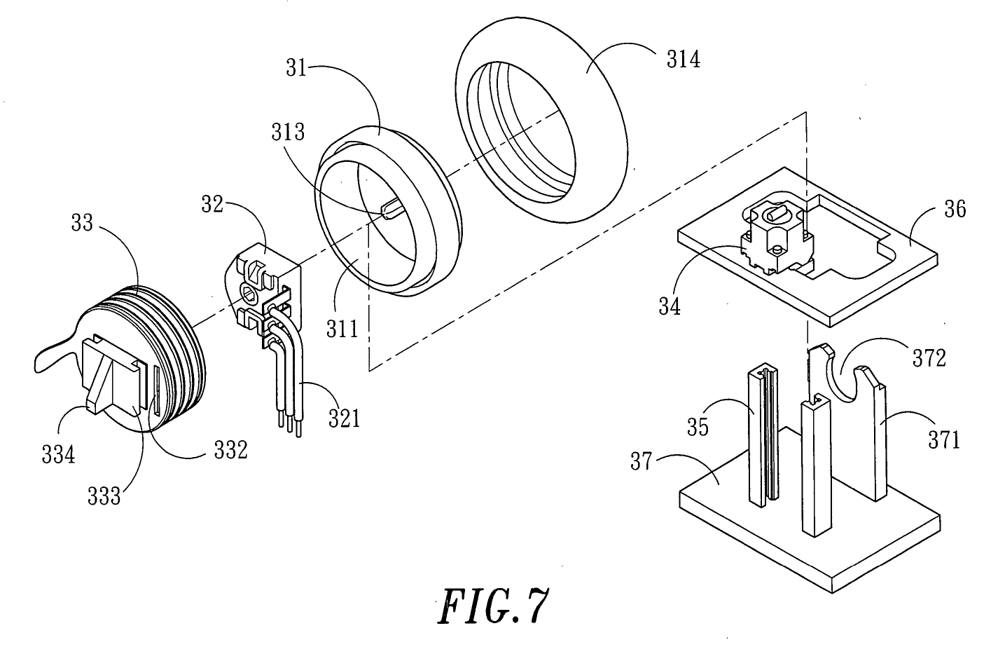

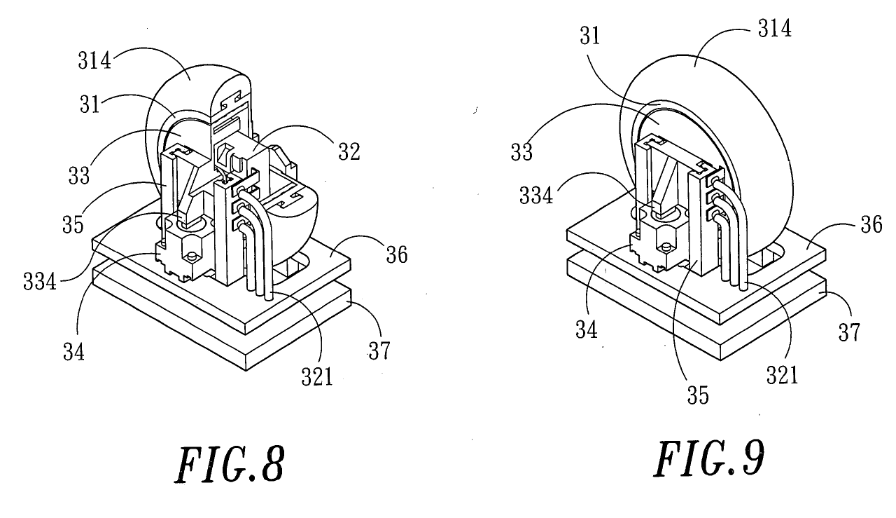

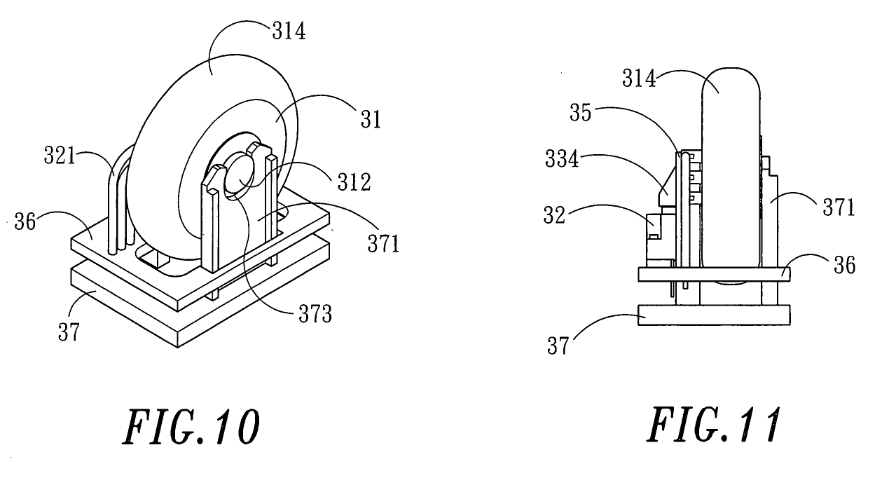

### LIST OF REFERENCE NUMERALS

11 Roller
13 Output shaft
21 Roller
23 Output shaft
25 Two positioning tracks
31 Roller
312 Rotation shaft
314 Circular piece
321 Wires
331 Space
333 Two positioning protrusions
34 Contact switch
36 Circuit board
371 Positioning plate
373 Additional space/passage
12 Encoder
14 Contact switch
22 Optical encoder
24 Contact switch
3 Contact switch
311 Groove
313 Output shaft
32 Encoder
33 Supporting seat
332 Slot
334 Activation protrusion
35 Two positioning tracks
37 Roller supporting seat
372 Hole

What is claimed is:

1. A roller structure for input devices, comprising:
a roller, having a groove provided on its side;
a supporting seat, disposed within the groove of said roller and providing a space on its side;
an encoder, fixedly disposed in the space of said supporting seat;
a circuit board, disposed under said roller and comprising a contact switch which may be activated by the downward movement of said supporting seat; and
a roller supporting seat, capable of carrying the aforesaid components.

2. The roller structure, as recited in claim 1, further comprising an output shaft provided in the groove and is inserted into said encoder.

3. The roller structure, as recited in claim 1, further comprising two positioning protrusions provided on the outside of the supporting seat and two positioning tracks provided on said roller supporting seat so that the movement of said supporting seat may be guided and limited by said roller supporting seat and wherein said structure further comprising an activation protrusion provided on the two positioning protrusions which is capable of activating the contact switch when the supporting seat is pressed down.

4. The roller structure, as recited in claim 1, further having a slot provided on said supporting seat so that wires of the encoder may be extended through the slot and so that the movement of said roller would not be hindered by the wires.

5. The roller structure, as recited in claim 1, further comprising a rotation shaft provided on the roller, a positioning plate provided on said roller supporting seat and having a hole provided on said positioning plate so as to allow said rotation shaft of said roller to rotate in the hole, wherein said roller structure further provides an additional space or passage provided on the hole so as to allow the downward movement of said roller.

6. The roller structure, as recited in claim 1, further comprising a circular piece which is made of a soft material such as rubber or plastic, being used to partially enclose said roller so as to improve the feel and make said roller structure easier to operate so that the piece may be replaced and cleaned up easily.
